(19) United States
(12) Patent Application Publication
(10) Pub. No.: US 2016/0375529 A1
(43) Pub. Date: Dec. 29, 2016

(54) RETROFITTING MANUFACTURING LINES INTO CLEANSPACE FABRICATORS

(71) Applicant: Frederick A. Flitsch, New Windsor, NY (US)

(72) Inventor: Frederick A. Flitsch, New Windsor, NY (US)

(21) Appl. No.: 13/747,091

(22) Filed: Jan. 22, 2013

Related U.S. Application Data
(60) Provisional application No. 61/593,501, filed on Feb. 1, 2012.

(51) Int. Cl. B23P 11/00

(52) U.S. Cl. CPC B23P 11/00

(57) ABSTRACT

The present invention provides various aspects for retrofitting existing manufacturing lines into cleanspace fabricators. In some embodiments existing processing equipment and automation are placed into the new environment. In other embodiments the processing equipment is placed and new automation equipment is used. And, in some embodiments the equipment of the existing manufacturing line including the automation are redesigned to allow for similar processing to occur in a cleanspace fabricator; where some of the redesign may also leverage strengths of the cleanspace fabricator design type.

### CROSS REFERENCE TO RELATED APPLICATIONS

This application claims priority to the U.S. Provisional Application No. 61/593,501, filed Feb. 1, 2012, entitled Retrofitting Manufacturing Lines into Cleanspace Fabricators, the contents of which are relied upon and incorporated herein.

### FIELD OF THE INVENTION

The present invention relates to apparatus and methods which support processing tools used in conjunction with cleanspace fabricators. More specifically, the present invention relates to methods and apparatus to redesign manufacturing lines into a cleanspace type of fabricator. In some embodiments, the said manufacturing lines before their redesign may operate in or out of a cleanroom environment.

### BACKGROUND OF THE INVENTION

A known approach to advanced technology fabrication of materials such as semi-conductor substrates, is to assemble a manufacturing facility as a “cleanroom.” In such cleanrooms, processing tools are arranged to provide aisle space for human operators or automation equipment. Exemplary cleanroom design is described in: “Cleanroom Design, Second Edition,” edited by W. Whyte, published by John Wiley & Sons, 1999, ISBN 0-471-94204-9, (herein after referred to as “the Whyte text” and the content of which is included for reference in its entirety).

Cleanroom design has evolved over time to include locating processing stations within clean hoods. Vertical unidirectional airflow can be directed through a raised floor, with separate cores for the tools and aisles. It is also known to have specialized mini-environments which surround only a processing tool for added space cleanliness. Another known approach includes the “ballroom” approach, wherein tools, operators and automation all reside in the same cleanroom.

Evolutionary improvements have enabled higher yields and the production of devices with smaller geometries. However, known cleanroom design has disadvantages and limitations.

For example, as the size of tools has increased and the dimensions of cleanrooms have increased, the volume of cleanspace that is controlled has concomitantly increased.

As a result, the cost of building the cleanspace, and the cost of maintaining the cleanliness of such cleanspace, has increased considerably.

Tool installation in a cleanroom can be difficult. The initial “fit up” of a “fab” with tools, when the floor space is relatively empty, can be relatively straightforward. However, as tools are put in place and a fabricator begins to process substrates, it can become increasingly difficult and disruptive of job flow, to either place new tools or remove old ones. Likewise it has been difficult to remove a sub-assembly or component that makes up a fabricator tool in order to perform maintenance or replace such a subassembly or component of the fabricator tool. It would be desirable therefore to reduce installation difficulties attendant to dense tool placement while still maintaining such density, since denser tool placement otherwise affords substantial economic advantages relating to cleanroom construction and maintenance.

There are many types of manufacturing flows and varied types of substrates that may be operated effectively in the mentioned novel cleanspace environments. It would be desirable to define standard methodology of design and use of standard componentry strategies that would be useful for manufacturing flows of various different types; especially where such flows are currently operated in non-cleanroom environments.

### SUMMARY OF THE INVENTION

Accordingly, there are novel methods to define cleanspace fabricators that incorporate elements from existing manufacturing lines. In some embodiments a cleanspace fabricator may be assembled with locations for process tools and a primary cleanspace location in which automation is found to move production units from tool to tool. Into the cleanspace, tools along with their existing automation components may be moved into the cleanspace fabricator and operated. In some embodiments a multilevel cleanspace fabricator may be formed and then when tools and automation are used from an existing fabricator there may also be installed automation that can move the production units from one level to a next level. The production units may be numerous types of elements of a production process that are acted on by processing tools to produce products; sometimes these units are substrates of various shapes and sizes which may be contained in carriers of various types.

In other embodiments, only the existing process tools may be added to the cleanspace manufacturing and new automation may be designed and installed. The new automation may be of a custom design or a straight forward design of standard cleanspace manufacturing types. Production units may be processed by various methods within the retrofitted manufacturing line as the production units are moved from process tool to process tool.

In still further embodiments the process tools as well as the automation may be redesigned and then installed into the cleanspace fabricator. The processes may be similar or identical to those that are run in the existing manufacturing lines and tools. The types of production units that are moved from tool to tool can be of the similar diversity discussed above, and may also be contained in carriers of different types while moving from tool to tool. In certain embodiments of this type, the redesigned process tool may be made of a size and form factor that it may be placed in a tool pod and tool carrier type of design which leverages advantages of the cleanspace fabricator type. Since the tools are nearly all or are all located on the periphery of the cleanspace, reversible removability of the tooling is made advantageous. In still further subsets of these embodiment types, the redesigned tooling may be made smaller, may process less production units per hour because of that but may consolidate some or all of the processing steps from the existing manufacturing line into a single entity. By installing many of these redesigned units into a cleanspace fabricator, the output of the fabricator may equal or exceed that of the original manufacturing line while improving the contamination and particulate aspects all with various efficiencies afforded by the cleanspace fabricator, tool pod and tool chassis novelties.

In some embodiments, the manufacturing line may need to have both particulate and biological contamination sources eliminated from the environment. The nature of the cleanspace fabricator and the primary cleanspace together with design aspects for the processing tools and carriers may allow for embodiments that allow for efficient production of various types of production units including in a non-limiting sense biomedical devices, semiconductor devices, Microelectromechanical systems, photonic devices, testing systems and other such production products.

The present invention can therefore include methods and apparatus for retrofitting existing manufacturing lines, for redesigning existing manufacturing tooling and automation systems into a cleanspace fabricator environment and for processing production units in these fabricators.

### BRIEF DESCRIPTION OF THE DRAWINGS

The accompanying drawings, that are incorporated in and constitute a part of this specification, illustrate several embodiments of the invention and, together with the description, serve to explain the principles of the invention:

FIG. 1 Overview of exemplary types of manufacturing process flows

FIG. 2 illustrates an exemplary comparison of spatial layouts for some embodiments of classic manufacturing tool layout and of the cleanspace type.

FIG. 3 illustrates a close-up of a generic processing environment including automation to move production units

FIG. 4 illustrates a close-up of a generic processing environment including automation to move work in progress which has been incorporated into a cleanspace fabricator environment as existing.

FIG. 5 illustrates an exemplary incorporation of existing processing lines into a cleanspace environment with automation between levels.

FIG. 6 illustrates a close-up of a generic processing environment including automation to move production units where the automation is made new in the cleanspace environment.

FIG. 7 illustrates an exemplary tooling layout in a cleanspace environment along with the new cleanspace environment automation to move from tool to tool.

FIG. 8 Illustrates different exemplary types of substrate carriers.

FIG. 9 illustrates different exemplary types of cleanspace fabricators consistent with concepts discussed.

### DETAILED DESCRIPTION

As manufacturing lines age and as product lifecycles progress, it is possible for a cleanliness requirement for products to evolve and to require changes in the inherent aspects of production. In some cases, the changes require new replacement tooling or improved materials aspects, while in others the environment that tooling resides in needs to be upgraded. Whether the current environment is a cleanroom type of environment or not, an effect means of retrofitting the environment may be to retrofit the existing manufacturing line into a cleanspace based fabricator manufacturing line.

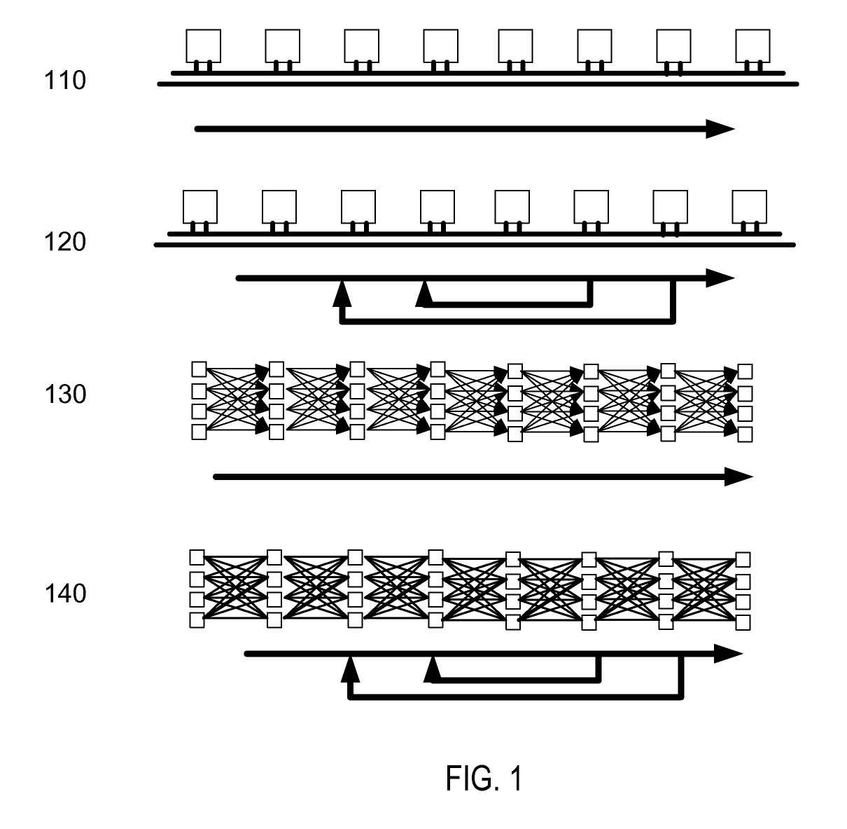

Proceeding to FIG. 1, item 110 demonstrates an exemplary case for manufacturing where the processing tools are located in a serial fashion. A work product is moved from one tool to the next tool after a process is complete and then by moving the work product to the end of the processing tools a complete product is obtained.

A somewhat different condition is demonstrated by item 120, where the processing tools are assembled in a serial fashion; however the automation and the processing flow entails the work product moving from certain tools back to tools that were previously involved in processing and perhaps forwards to tools not yet involved in processing. The characteristics of such a flow may allow for improved cost aspects for end products, but may result in much more complicated operational control and planning.

A different situation is again demonstrated as item 130. In this type of flow there may be multiple tools of a particular tool type, or of all tool types. When a substrate proceeds to a particular tool type it may then be processed by one of a multiple number of tools of that type. This situation as well has more complicated logistics than the first example in item 110. However, advantages in the logistical flow can be quite important. For example if one of the processing tools of a particular type is not functioning and may need to be repaired, the work flow may proceed through one of the equivalent types of tools without the significant delays that would happen in a linear processing flow with one tool at each process step.

A still further different manufacturing condition may be demonstrated by item 140 where there are multiple tools of the various types and the processing can proceed in a haphazard manner from one tool type to another until the processing is complete. This is still higher in complexity than any of the other situations discussed. There may be numerous manners to operate a production flow of this type including for example allowing any work product to go through any of the multiple tools at a particular processing step to having dedicated tools for the processing at a particular processing step in the work product flow where use of other tools is only done under special circumstances.

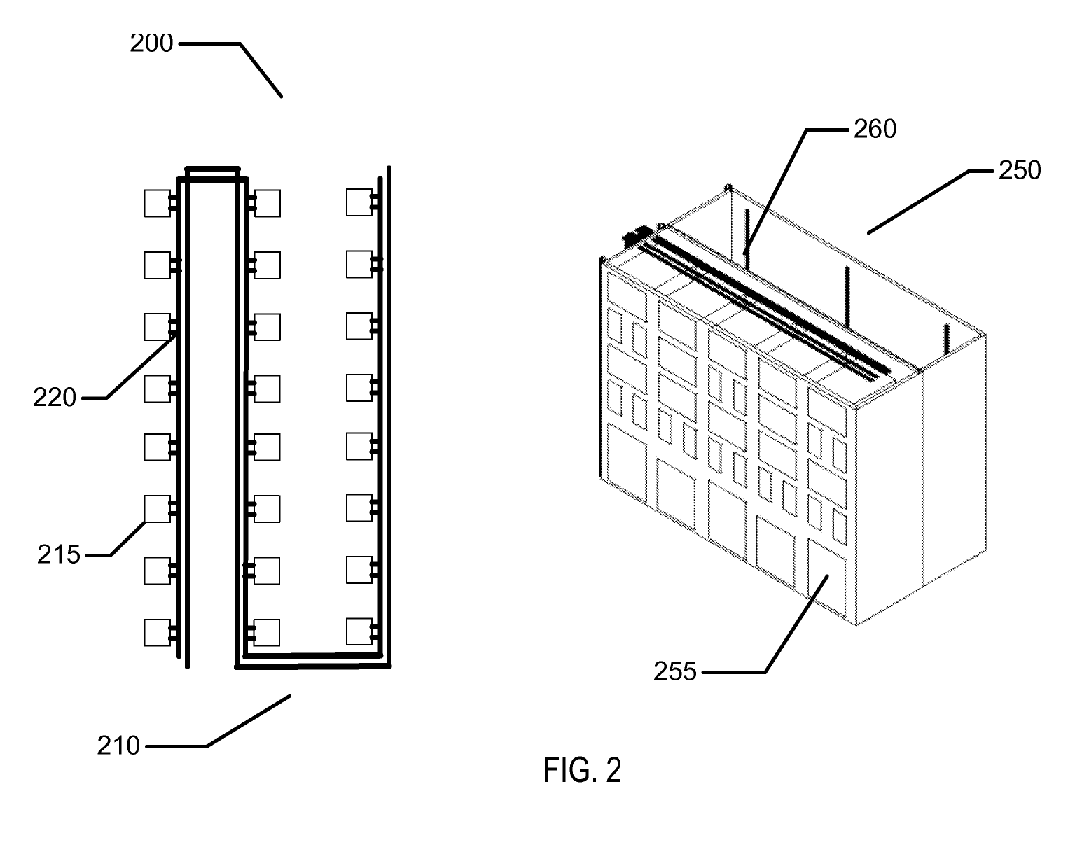

Each of these types of manufacturing flows may be consistent with retrofitting to a fabricator of a cleanspace type. As an example consider the example of item 200, FIG. 2. In this example item 210 may represent an exemplary manufacturing line of the types shown as items 110 and 120. The line may have numerous tools as for example, one of them being item 215. Furthermore, the work product may be moved from tool to tool on an automation system depicted as item 220. In an exemplary sense, it may be necessary to retrofit this manufacturing line because it may have been determined that the environment of manufacturing line 210 is of an insufficient cleanliness level. Item 250, in FIG. 2, may demonstrate one of the embodiments of a cleanspace fabricator that is a possible design to retrofit the manufacturing line into. This design would have the processing tools 255, arranged in a matrix along horizontal rows extending multiple levels in a vertical direction. The design has an efficient cleanspace for the movement of substrates from tool to tool shown as item 260. In the region of item 260 may be located automation systems that handle substrates or in some embodiments substrates inside substrate carriers. By appropriate flow of filtered air, the region may be brought to a very good cleanliness level. Furthermore, due to the nature of the design the space used for the automation and movement may be very small; a fact that allows for efficient operations and an easier environment to treat in cases where the cleanliness needs refer both to particulate forms and biological forms.

### Determining the Cause of Particulates in the Manufacturing Operation

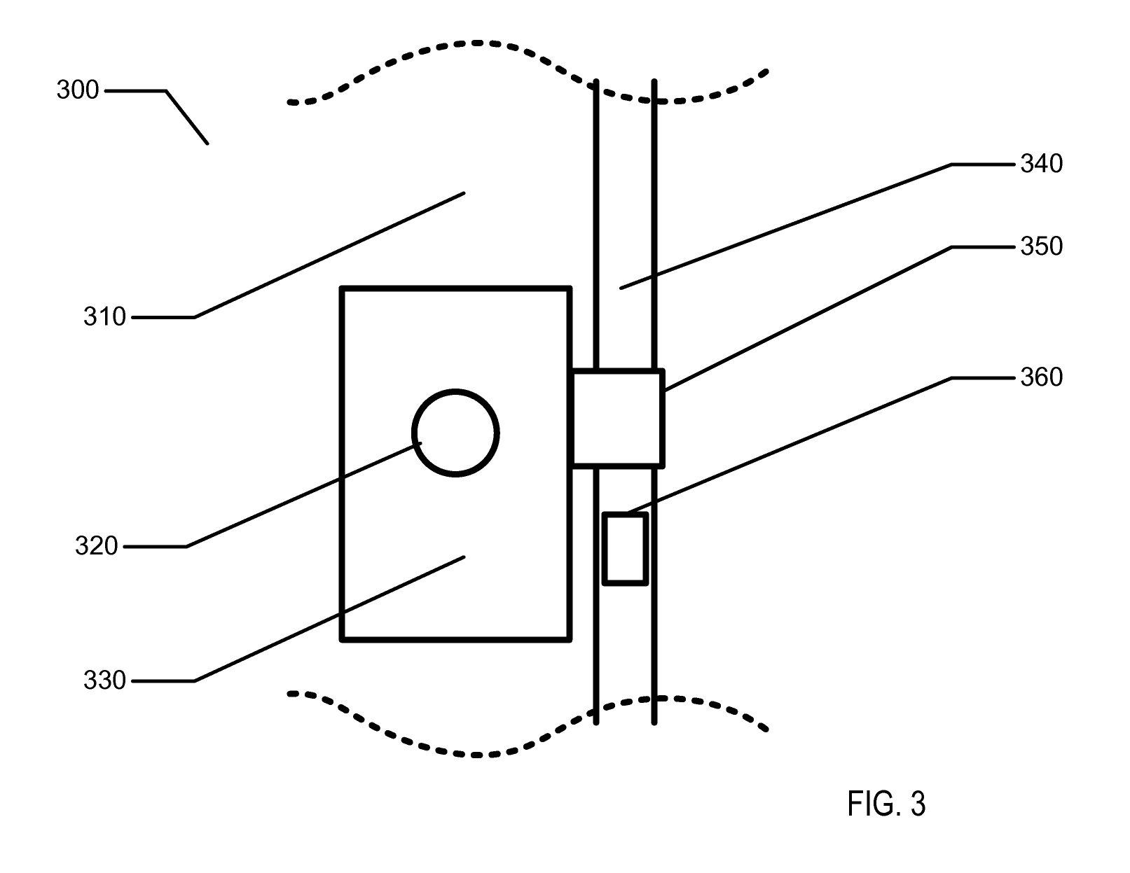

Proceeding to FIG. 3, item 300 a model of a process tool in a manufacturing line is depicted. The tool, item 330, resides in an operating environment depicted as item 310. In the same environment is also located the automation system used to move work in process from tools to tools, item 340. At each of the tools in some embodiments will be a means of moving product substrates into the processing tool, an exemplary depiction of such an apparatus is shown in an exemplary manner as item 350. In some embodiments a single substrate may move from tool to tool, in other embodiments collections of substrates will move. In either case the substrates may in some embodiments be contained in a carrier as they are moved between tool to tool. For example, such a carrier may be represented as item 360 in FIG. 3.

When determining a course of upgrading the manufacturing line due to an increase in cleanliness requirements. One important step may involve determining the nature and source of the existing level of contamination that occurs in the current line. There may be many different sources of the contaminations that occur. Identifying and segregating those sources are key in determining the full nature of retrofitting needed. For example if the entire source of contamination were determined to be the environment alone, then installation of the facility into a cleanspace or cleanroom may result in an acceptable product characteristic.

Some of the likely sources to partition out may include for example, 320 the processing environment (s) of the production process. Each of these tool processing environments may inherently be contributing contaminants to the product. In this case, a change of the operating environment cleanliness may not be sufficient to yield an acceptable end result in its own right. Work would need to be performed to understand if the processing conditions and materials and the nature of the processing environments could be improved in straight forward manners or whether an entire new set of tools will also be required in addition to environment.

The automation components, like items 340, 350 and 360 may also be a major source of contamination. The system that moves carriers or substrates between tools, item 340 may generate significant levels of contamination. Or the equipment to move the carriers or substrates into the processing tool, item 350, may be a source of contaminant. Or, the container that carries the substrates or is the substrates may be a source of contaminants, item 360. In cases where the automation components add significant major source of contamination it may be possible that a retrofit to a cleanspace fabricator environment may offer an alternative means of moving substrates from tool to tool that may be attractive when compared to upgrading the existing automation equipment and materials solutions for improved cleanliness.

Except when the environment, 310, is determined to not add contaminants to the product and a “cleaner” environment is not needed, a cleanspace based fabricator may represent an ideal infrastructure as part of the solution of retrofitting manufacturing lines. In addition to being a solution that is clean, it will also be a much more compact, lower operational cost solution with lower infrastructure cost immediately as well. Furthermore, a cleanspace fabricator has the unique property where substantially all the tools exist on the periphery of the fabricator cleanspace. This provides operational advantages for a fab that may be particularly significant for smaller sized tooling.

In the following sections, description will be given to those cases where an upgrade to the environment is required. Some, exemplary solutions to the particular cases will be described with description of some embodiments of the cleanspace fabricator type. It may be apparent to one skilled in the arts, that the diversity of solutions within the various types of embodiments of cleanspace fabricators are within the scope of the inventive art herein, and are broadly included as additional alternatives.

### Embodiments Where Automation Exists and is Clean

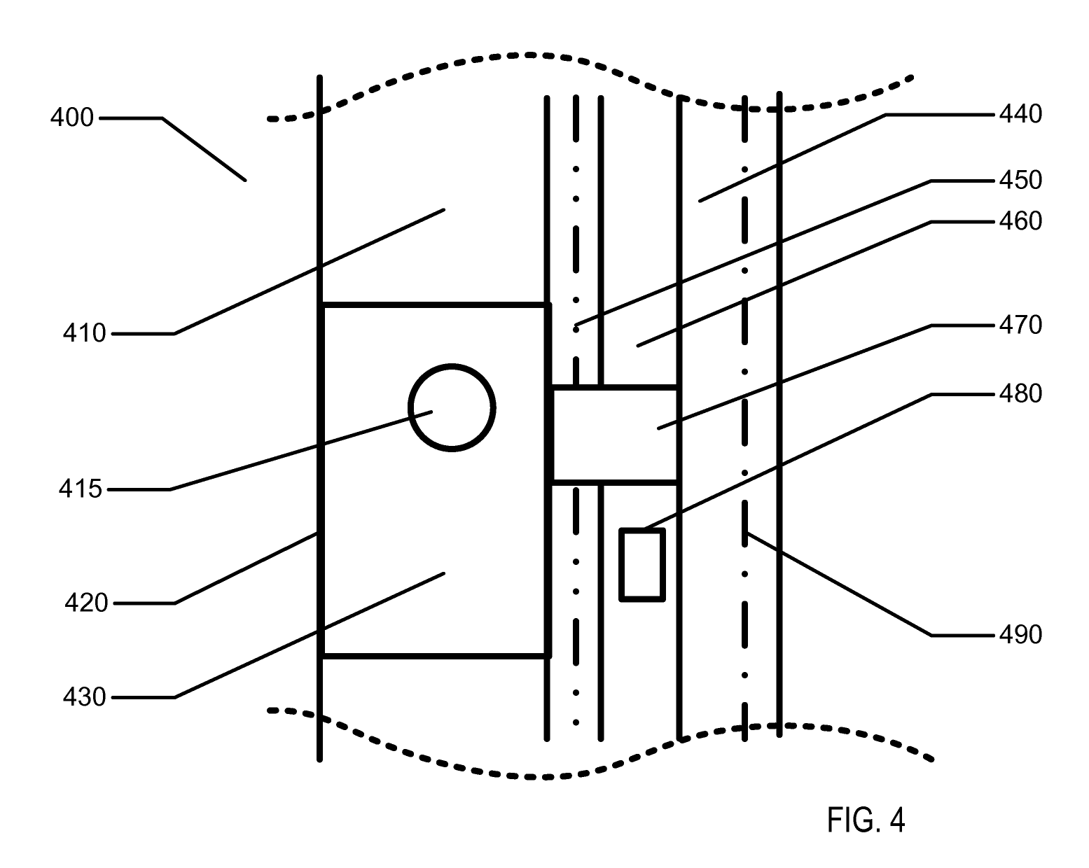

In the case where the automation that is currently employed in a manufacturing line is sufficiently “clean” in its own right then the existing fabricator system may be included into a cleanspace fabricator in some straightforward manners. Inherently in many of these embodiments, the contamination performance of the tooling and the substrate carrier components will also be adequate for the new requirements. In such cases, and proceeding to FIG. 4, item 400 a description of how the existing tooling and automation may be incorporated into a cleanspace fabricator is shown. The depiction is a cutout view of a single tool with its automation which has now been included into a cleanspace fabricator type. Item 420 demonstrates the inclusion of a cleanspace wall or boundary on the “outside” of the process tool, item 430. On the other side, or “inside” of the process tool another cleanspace boundary, item 450 is included. The presence of these two boundaries creates a cleanspace, item 410. This cleanspace would be classified in typical embodiments as a secondary cleanspace that contains the bodies of the tools within it.

The cleanspace boundary, 450 is depicted with a dashed line. In some embodiments a flow of air will be directed through the wall or through hepa filters mounted on the wall across a primary cleanspace 440, which involves the transport of carriers or substrates from tool to tool. The airflow will continue to a second air receiving wall or boundary of the primary cleanspace labeled as item 490. This architecture allows for a very high level of cleanliness to be defined and maintained where the substrates are moving from tool to tool.

Also, at least partially within the primary cleanspace 440, may be located the tool port, item 470 which is used to move carriers or substrates into the internal spaces of the tool body, 430 which may include a processing environment or chamber, 415. The carriers or substrates, item 480, may move along an automation system, item 460 from tool ports to tool ports. In some embodiments where the existing automation system is incorporated into the cleanspace fabricator, the movement from a tool port to a tool port may occur only in a fixed horizontal direction.

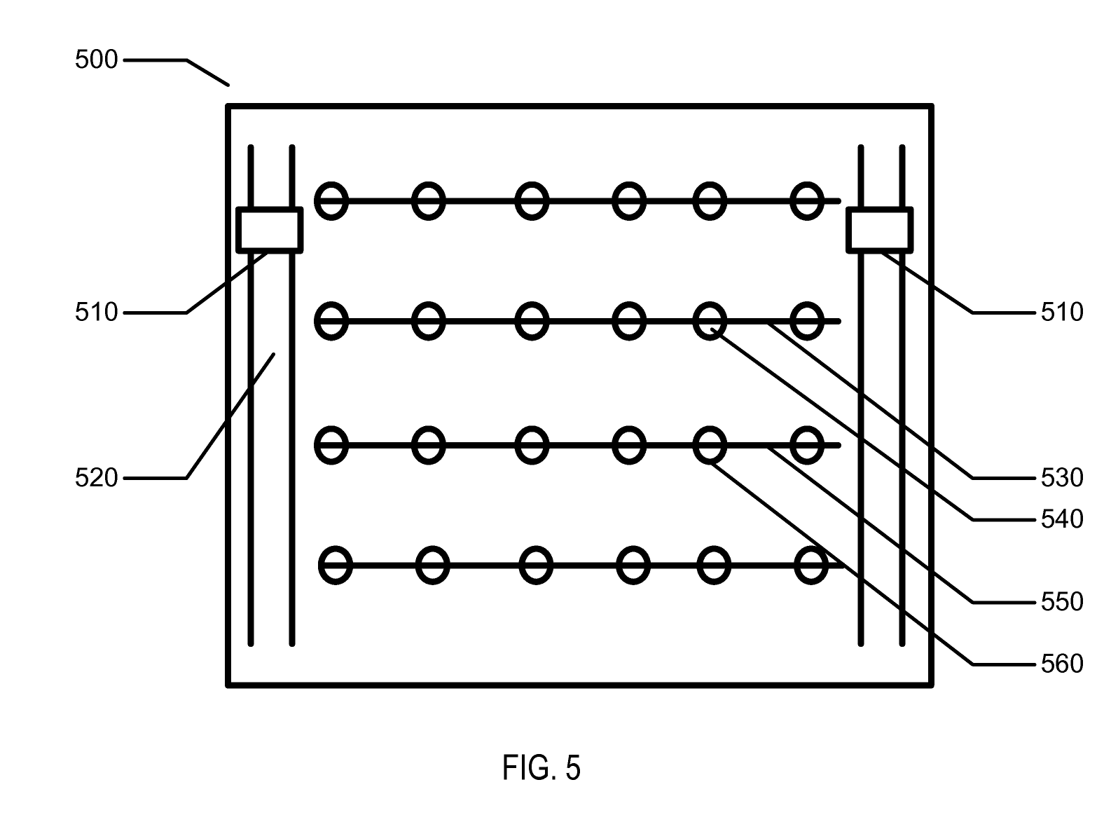

Proceeding to FIG. 5, item 500, a depiction of the deployment of processing tools into the cleanspace fabricator is shown in cross section. In some embodiments where the automation is incorporated in its existing form it may have horizontally deployed automation. The automation may be broken down into segments the length of the cleanspace as depicted by items 530 and 550. Since the processing may proceed along the horizontally deployed levels. The substrates or carriers may move along the horizontal automation systems and to a tool port for example as shown by item 540. As the processing proceeds the substrate or carrier may need to move from level 530 to level 550 for example. In some embodiments there may be an automation system that allows for the movement between levels. Examples of such intra-level automation may be depicted by the automation units identified as items 510. There may be numerous manners to move substrates or carriers between levels, and in one embodiment type the automation units may move along vertical rail systems as shown by item 520. If the substrate or carrier is moved from level 530 to 550, it may next be moved along the horizontal automation of item 550 to the toolport 560. It may be apparent to those skilled in the art that there may be numerous designs of existing manufacturing lines and automation systems and the embodiments depicted may be modified to accommodate various changes as for example there may be multiple levels to the automation or it may not be linear or other such changes. The various changes of cleanspace fabricator design to accommodate various existing line designs are intended to be within the scope of the inventive art herein.

### Embodiments Where Automation Contributes Significantly to Contamination

In some circumstances, analysis of the existing manufacturing line may reveal that the automation equipment contributes contamination to the environment in significant levels. In some of these cases then the placement of the manufacturing line and automation into a cleanspace may not be sufficient to result in an acceptable end product due to the contamination. The general nature of a cleanspace fabricator allows for embodiments that effectively solve this need.

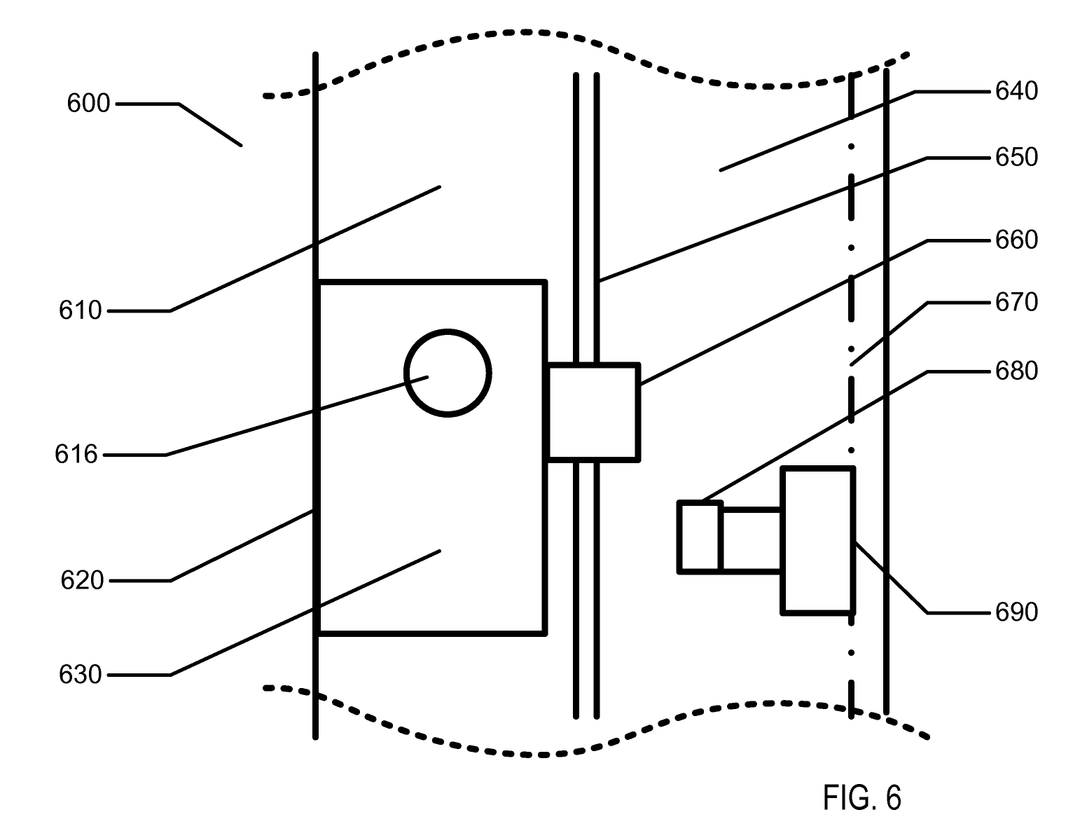

Proceeding to FIG. 6, item 600, a depiction of incorporating existing process tools into cleanspace fabricators is made. The automation system of the line, in some embodiments may be replaced with a fab-wide automation system as some cleanspace embodiments may have. As shown a process tool, item 630, may be located in a secondary cleanspace, 610, that may be located between exterior walls as for example item 620 may represent and an interior wall as 650 may represent. In some embodiments, the airflow may proceed in the primary cleanspace 640 from wall 650, which would then be an air source wall, to wall 670, which would then be an air receiving wall. In some embodiments the airflow may be characterized as a laminar flow, or in others as a uni-directional flow and in still others as a non uni-directional flow. The air may flow out of penetrations in the wall itself (In the case of the air source wall). Or, in alternatives there may be hepa filters as part of the wall or the wall itself and the air flow may come out of the hepa filter as it proceeds across the primary cleanspace, 640.

Referring again to FIG. 6, item 600, the fab automation system may be represented as item 690. In some embodiments the automation system may be attached to the back wall, item 670; however, numerous alternative embodiments may be possible including as a non-limiting example, the automation system being attached to the top of the multilayer cleanspace. The automation will move a substrate or in some embodiments a carrier that contains one or more substrates, item 680, to a tool port, item 660 which is capable of receiving the substrate or carrier and move the substrate to within tool body, 630. After processing the tool body may be moved out of the tool port 660 and back to the automation system. It may be apparent that numerous alternatives to this may occur, including for example that there may be multiple ports connected to a tool body where in some embodiments one port would act to receive substrates for the tool and the other would act to discharge substrates.

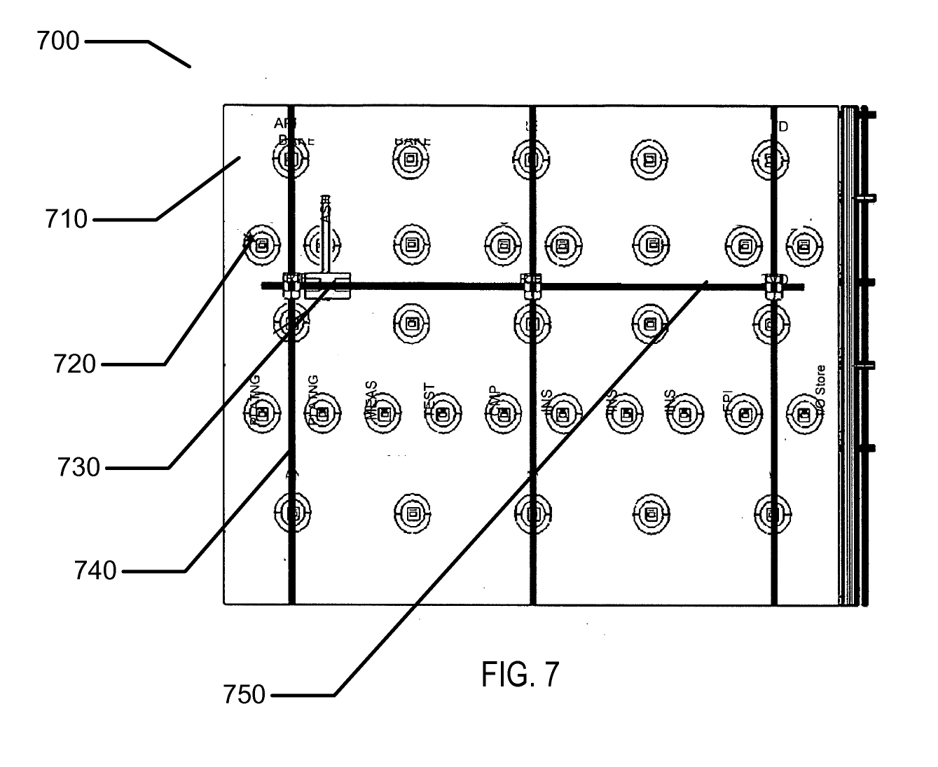

Referring to FIG. 7, item 700, a depiction of the inside of the primary cleanspace of FIG. 6 while looking at wall 650, which in this drawing is now represented in plan view as item 710, may be observed. Multiple tool ports may be represented as the round shaped features, as an example item 720. In this perspective view the automation may, in a non-limiting example embodiment, consist of linear rails that allow movement along a vertical dimension, item 740, for example and along a horizontal dimension, item 750. The automation handler that receives carriers or substrates may be identified as item 730. It may be noticed in this example that since the automation is able to address any tool port by a direct movement from a first tool port that the layout of the tool bodies and the associated location of the tool ports may be less structured as compared to previous examples. As may be apparent, there may be numerous manners to deploy tools and handle substrates within the primary cleanspace that would be consistent with the art herein.

Referring back to FIG. 6, item 600 the tool 630 may have schematically represented as item 616 a processing environment where substrates may have processes performed upon or to them. In some circumstances, an original tool from an existing manufacturing line may have a processing environment, 616, where particulates are significantly added to substrates being processed within. This may be for a number of reasons including material aspects of the processor design or other aspects of the processor design that generate or free particulates to interact with the substrate under processing. In this case, in some embodiments, this condition may cause a special case for the incorporation of manufacturing lines into cleanspaces. In some cases, just one tool may have the issue in question and it may be rebuilt or redesigned before being located in a cleanspace fabricator.

In other embodiments, it may be desirable to regenerate all of the tooling that is used in the existing manufacturing line. There may be numerous methods to perform this regeneration ranging from rebuilding the processing, automation, control or “tool-port” regions of the tool to redesigning the materials or component aspects within the processing tool. In some embodiments, it may be desirable to redesign the entire tool itself. In such cases, the design choices may include tradeoffs that incorporate aspects that improve the efficiency of a cleanspace fabricator. If the tools can be made small to process the substrate, then the incorporation of the tool pod and tool chassis aspect of some embodiments of a cleanspace fabricator may allow for the leverage of reversibly placing and removing tool bodies through the peripheral wall of the fabricator. As mentioned in prior descriptions some of which have been incorporated by reference herein, small replaceable tools may allow for efficiency of operation and the ability of a fabricator to operate with minimal staffing requirements since tools may be repaired off line or at remote locations, but the fabricator can be made operational by the placement of a functioning copy of the tool. Another advantage of smaller tools may be that there can be more units of them economically placed in the new cleanspace fabricator. As was described in item 140, FIG. 1, the multiple tools that may be flexibly used in a manufacturing flow may allow for advantages from a manufacturing perspective. Multiple paths may improve the cycle times of production and flexibility of the manufacturing processing as well for example. There may be numerous manners to incorporate a new tool design and optimize the aspect of its placement into a cleanspace fabricator for the function of performing existing manufacturing steps or perhaps improved manufacturing steps.

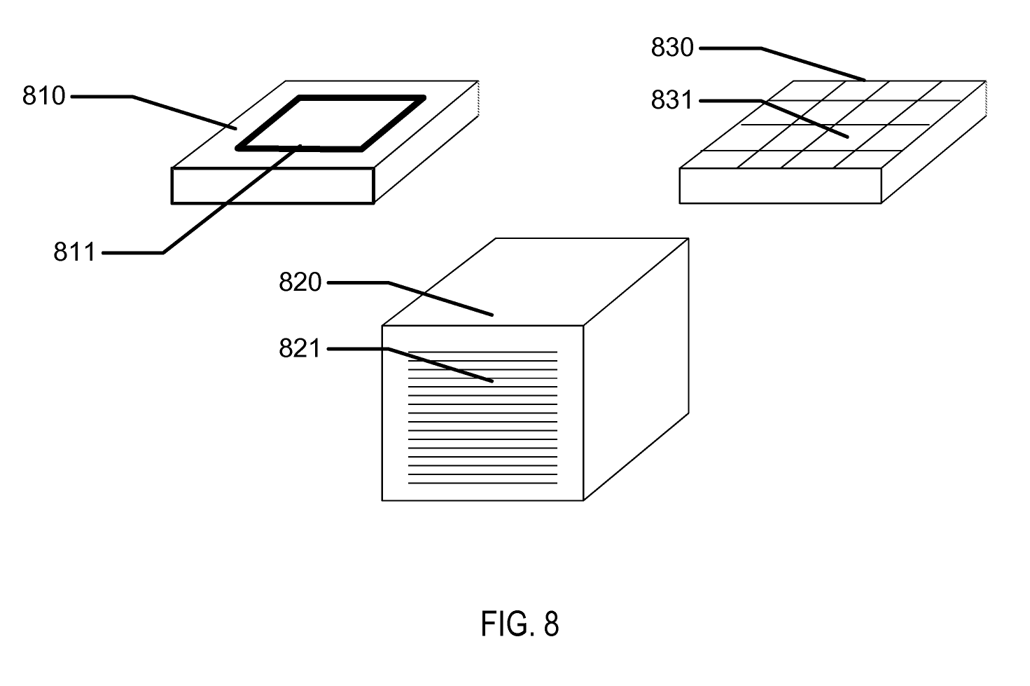

Proceeding to FIG. 8, there have been numerous mentions of the fact that the cleanspace fabricator and the automation within it may handle substrates or carriers that contain a substrate or multiple substrates. Item 810 may be intended to depict a carrier that contains a single substrate, item 811. These substrates may be of various types of shapes as wafers which are typically round to squares as depicted in the figure to other shapes.

Item 820 depicts a carrier that may contain numerous substrates, 821, within it. The same diversity of shapes and materials may comprise acceptable types of carriers. The carrier itself may be capable of supporting a protected clean environment within its boundaries. In a non-limiting exemplary sense, when the carrier is containing semiconductor wafers, some of these carriers may include SMIF or FOUP type carriers. However, any carrier capable of containing substrates and being handled by automation in the manners previously described would constitute acceptable embodiments of the art herein.

Sometimes the substrates may be contained within a carrier where the substrates are located next to each other. Item 831 may represent one exemplary substrate contained in such a carrier 830. These individual cells or wells may contain various shapes and materials as substrates. Here too, in some embodiments, the carrier may be able to maintain a clean environment around the substrates as they are transported. Still further diversity may come from the fact that the entire item 830 may be considered a substrate where the multiple wells will be processed with processing tools to form a product or products within the wells, 831, of the substrate 830.

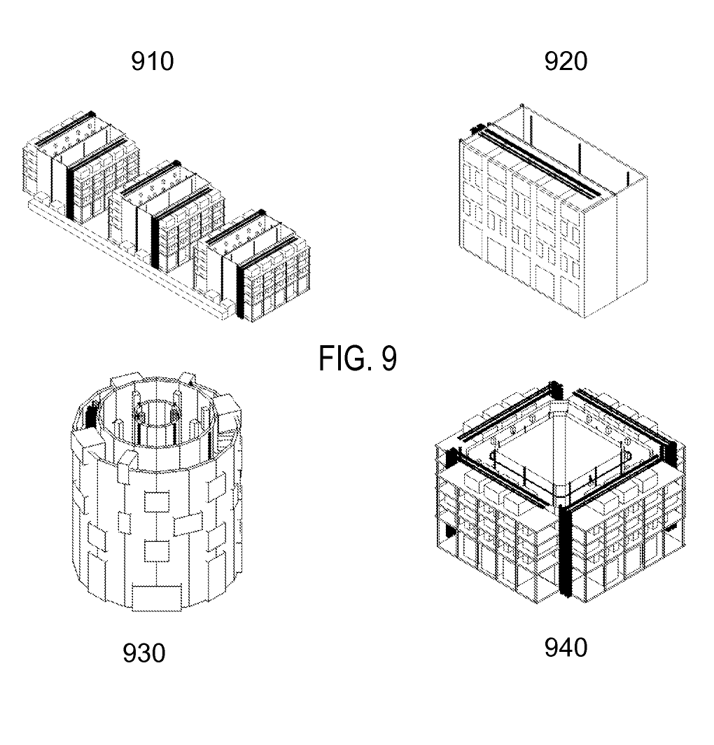

There are numerous types of cleanspace fabricators that may be consistent with the art described herein. Much of the discussion has been made in connection to vertically oriented, generally planar embodiments of a cleanspace. Referring to FIG. 9, item 900, item 920 may represent a depiction of the general shape of such cleanspace fabricators. However, numerous other types of cleanspace fabricators and combinations of cleanspace fabricators may be consistent with the art herein. For example, compound versions of the generally planar, vertically oriented fabs may be observed as item 910. There may also be tubular and annular tubular types of designs. Item 930 depicts a round annular tubular type cleanspace fabricator; while, item 940 may depict a rectilinear annular tubular type cleanspace fabricator. The exact nature of the cleanspace fabricator, as may be apparent, may exist in all the diversity of types of cleanspace fabricators and be consistent with establishing a retrofitting of existing manufacturing lines into cleanspace fabricators.

### Glossary of Selected Terms

Air receiving wall: a boundary wall of a cleanspace that receives air flow from the cleanspace.
Air source wall: a boundary wall of a cleanspace that is a source of clean airflow into the cleanspace.
Annular: The space defined by the bounding of an area between two closed shapes one of which is internal to the other.
Automation: The techniques and equipment used to achieve automatic operation, control or transportation.
Ballroom: A large open cleanroom space devoid in large part of support beams and walls wherein tools, equipment, operators and production materials reside.
Batches: A collection of multiple substrates to be handled or processed together as an entity
Boundaries: A border or limit between two distinct spaces—in most cases herein as between two regions with different air particulate cleanliness levels.
Circular: A shape that is or nearly approximates a circle.
Clean: A state of being free from dirt, stain, or impurities—in most cases herein referring to the state of low airborne levels of particulate matter and gaseous forms of contamination.
Cleanspace: A volume of air, separated by boundaries from ambient air spaces, that is clean.
Cleanspace, Primary: A cleanspace whose function, perhaps among other functions, is the transport of jobs between tools.
Cleanspace, Secondary: A cleanspace in which jobs are not transported but which exists for other functions, for example as where tool bodies may be located.
Cleanroom: A cleanspace where the boundaries are formed into the typical aspects of a room, with walls, a ceiling and a floor.
Core: A segmented region of a standard cleanroom that is maintained at a different clean level. A typical use of a core is for locating the processing tools.
Ducting: Enclosed passages or channels for conveying a substance, especially a liquid or gas—typically herein for the conveyance of air.
Envelope: An enclosing structure typically forming an outer boundary of a cleanspace.
Fab (or fabricator): An entity made up of tools, facilities and a cleanspace that is used to process substrates.
Fit up: The process of installing into a new clean room the processing tools and automation it is designed to contain.
Flange: A protruding rim, edge, rib, or collar, used to strengthen an object, hold it in place, or attach it to another object. Typically herein, also to seal the region around the attachment.
Folding: A process of adding or changing curvature.
HEPA: An acronym standing for high-efficiency particulate air. Used to define the type of filtration systems used to clean air.
Horizontal: A direction that is, or is close to being, perpendicular to the direction of gravitational force.
Job: A collection of substrates or a single substrate that is identified as a processing unit in a fab. This unit being relevant to transportation from one processing tool to another.
Logistics: A name for the general steps involved in transporting a job from one processing step to the next. Logistics can also encompass defining the correct tooling to perform a processing step and the scheduling of a processing step.
Multifaced: A shape having multiple faces or edges.
Nonsegmented Space: A space enclosed within a continuous external boundary, where any point on the external boundary can be connected by a straight line to any other point on the external boundary and such connecting line would not need to cross the external boundary defining the space.
Perforated: Having holes or penetrations through a surface region. Herein, said penetrations allowing air to flow through the surface.
Peripheral: Of, or relating to, a periphery.
Periphery: With respect to a cleanspace, refers to a location that is on or near a boundary wall of such cleanspace. A tool located at the periphery of a primary cleanspace can have its body at any one of the following three positions relative to a boundary wall of the primary cleanspace: (i) all of the body can be located on the side of the boundary wall that is outside the primary cleanspace, (ii) the tool body can intersect the boundary wall or (iii) all of the tool body can be located on the side of the boundary wall that is inside the primary cleanspace. For all three of these positions, the tool's port is inside the primary cleanspace. For positions (i) or (iii), the tool body is adjacent to, or near, the boundary wall, with nearness being a term relative to the overall dimensions of the primary cleanspace.
Planar: Having a shape approximating the characteristics of a plane.
Plane: A surface containing all the straight lines that connect any two points on it.
Polygonal: Having the shape of a closed figure bounded by three or more line segments
Process: A series of operations performed in the making or treatment of a product—herein primarily on the performing of said operations on substrates.
Production unit: An element of a production process that is acted on by processing tools to produce products. In some cleanspace fabricators this may include carriers and/or substrates.
Robot: A machine or device that operates automatically or by remote control, whose function is typically to perform the operations that move a job between tools, or that handle substrates within a tool.
Round: Any closed shape of continuous curvature.
Substrates: A body or base layer, forming a product, that supports itself and the result of processes performed on it.
Tool: A manufacturing entity designed to perform a processing step or multiple different processing steps. A tool can have the capability of interfacing with automation for handling jobs of substrates. A tool can also have single or multiple integrated chambers or processing regions. A tool can interface to facilities support as necessary and can incorporate the necessary systems for controlling its processes.
Tool Body: That portion of a tool other than the portion forming its port.
Tool Port: That portion of a tool forming a point of exit or entry for jobs to be processed by the tool. Thus the port provides an interface to any job-handling automation of the tool.
Tubular: Having a shape that can be described as any closed figure projected along its perpendicular and hollowed out to some extent.
Unidirectional: Describing a flow which has a tendency to proceed generally along a particular direction albeit not exclusively in a straight path. In clean airflow, the unidirectional characteristic is important to ensuring particulate matter is moved out of the cleanspace.
Unobstructed removability: refers to geometric properties, of fabs constructed in accordance with the present invention that provide for a relatively unobstructed path by which a tool can be removed or installed.
Utilities: A broad term covering the entities created or used to support fabrication environments or their tooling, but not the processing tooling or processing space itself. This includes electricity, gasses, airflows, chemicals (and other bulk materials) and environmental controls (e.g., temperature).
Vertical: A direction that is, or is close to being, parallel to the direction of gravitational force.

While the invention has been described in conjunction with specific embodiments, it is evident that many alternatives, modifications and variations will be apparent to those skilled in the art in light of the foregoing description. Accordingly, this description is intended to embrace all such alternatives, modifications and variations as fall within its spirit and scope.

1. A method for forming a cleanspace fabricator; said method comprising:
constructing a cleanspace fabricator structure wherein at least a primary cleanspace is included wherein an air source provides air flow through the primary cleanspace in a direction from a first vertical wall to a second vertical wall and through at least a portion of the first vertical wall and through at least a portion of the second vertical wall;
obtaining a first processing tool, wherein the first processing tool previously occupied a location within a clean room fabricator, wherein within the clean room fabricator the first tool processed a first substrate, and wherein the clean room fabricator is not physically connected to the cleanspace fabricator;
moving the first processing tool to the cleanspace fabricator;
placing the first processing tool into said cleanspace fabricator structure; and
configuring an automation system to move a first production unit from the first processing tool to second processing tool.

2. The method of claim 1 wherein:
the cleanspace fabricator is comprised of multiple vertical levels, wherein a first vertical level with the first processing tool is located beneath a second vertical level with the second processing tool.

3. The method of claim 1 further comprising:
obtaining a first automation component, wherein the first automation component previously occupied a location within the clean room fabricator, wherein within the clean room fabricator the first automation component assisted the transport of a substrate to the first processing tool;
moving the first automation component to the clean space fabricator;
placing the first automation component into the clean space fabricator, wherein the first automation component becomes a portion of the automation system.

4. The method of claim 2 further comprising:
obtaining a first automation component, wherein the first automation component previously occupied a location within the clean room fabricator, wherein within the clean room fabricator the first automation component assisted the transport of a substrate to a second processing tool;
moving the first automation component to the clean space fabricator;
placing the first automation component into the clean space fabricator, wherein the first automation component becomes a portion of the automation system.

5. The method of claim 4 further comprising:
Obtaining a second automation component wherein the second automation component supports the movement of production units from the first vertical level to the second vertical level; and
wherein the second automation component interfaces with the first automation component to receive a production unit from the first automation component., .

6. (canceled)

7. The method of claim 1 wherein:
a portion of the first production unit supports a product but is not included in a final product.

8. The method of claim 5 wherein:
a portion of the first production unit supports a product but is not included in a final product.

9. (canceled)

10. A method of forming a product; said method comprising:
constructing a cleanspace fabricator structure wherein at least a primary cleanspace is included wherein an air source provides air flow through the primary cleanspace in a direction from a first vertical wall to a second vertical wall and through at least a portion of the first vertical wall and through at least a portion of the second vertical wall;
obtaining a first processing tool, wherein the first processing tool previously occupied a location within a clean room fabricator, wherein within the clean room fabricator the first tool processed a first substrate, and wherein the clean room fabricator is not physically connected to the cleanspace fabricator;
moving the first processing tool to the cleanspace fabricator;
placing the first processing tool into said cleanspace fabricator structure; and
performing a first process on a first production unit in the first processing tool.

11. (canceled)

12. (canceled)

13. (canceled)

14. (canceled)

15. (canceled)

16. (canceled)

17. (canceled)

18. (canceled)

19. (canceled)

20. (canceled)

21. The method of claim 10 wherein the cleanspace fabricator is comprised of multiple vertical levels, wherein a first vertical level with the first processing tool is located beneath a second vertical level with a second processing tool.

22. (canceled)

23. (canceled)

24. (canceled)

25. A method for forming a cleanspace fabricator; said method comprising:
constructing a cleanspace fabricator structure wherein at least a primary cleanspace is included wherein an air source provides air flow through the primary cleanspace in a direction from a first vertical wall to a second vertical wall and through at least a portion of the first vertical wall and through at least a portion of the second vertical wall, and wherein the cleanspace fabricator is comprised of multiple vertical levels, wherein a first vertical level with the first processing tool and a second processing tool is located beneath a second vertical level with the third processing tool, wherein the first processing tool is located along the periphery of the first vertical wall, and wherein the first processing tool is reversibly removable;
adding a first linear motion track to the cleanspace fabricator, wherein a substrate carrier rides upon the first linear motion track in a horizontal motion between tools on the first vertical level.

26. The method of claim 25 further comprising:
adding a second linear motion track to the cleanspace fabricator, wherein the substrate carrier rides upon the second linear motion track in a horizontal motion between processing tool on the second vertical level;
adding a first vertical elevator track to the cleanspace fabricator, wherein the substrate carrier rides upon the first vertical elevator track in a vertical motion between the first linear motion track and the second linear motion track.
